(19) United States
(12) Patent Application Publication
(10) Pub. No.: US 2022/0200380 A1
(43) Pub. Date: Jun. 23, 2022

(54) ROTOR AND MOTOR

(71) Applicant: Nidec Corporation, Kyoto (JP)

(72) Inventor: Tatsuki SHIGETA, Kyoto (JP)

(21) Appl. No.: 17/558,066

(22) Filed: Dec. 21, 2021

(30) Foreign Application Priority Data
Dec. 22, 2020 (JP) 2020-212590

(51) Int. Cl. H02K 1/2783; H02K 1/24

(52) U.S. Cl. CPC H02K 1/2783; H02K 1/24

(57) ABSTRACT

A rotor rotatable about a center axis extending in an axial direction. The rotor includes an annular rotor core, a rotor magnet fixed to an inner surface of the rotor core in a radial direction, and a protection portion that presses the rotor magnet against the rotor core from an inside in the radial direction, and fixes the rotor core and the rotor magnet.

### CROSS REFERENCE TO RELATED APPLICATION

The present application claims priority under 35 U.S.C. § 119 to Japanese Patent Application No. 2020-212590, filed on Dec. 22, 2020, the entire contents of which are hereby incorporated herein by reference.

### 1. FIELD OF THE INVENTION

The present disclosure relates to a rotor and a motor.

### 2. BACKGROUND

An outer-rotor motor in which a rotor magnet is disposed on an outside of a stator in a radial direction is known. For example, a motor used in a conveying device of a semiconductor manufacturing apparatus is described as such an outer-rotor motor.

In the outer-rotor motor described above, when an electromagnetic force acting between the rotor magnet and the stator increases as an output of the motor increases, the rotor magnet may be detached, fall off, and scatter.

### SUMMARY

One example embodiment of a rotor of the present disclosure is a rotor rotatable about a center axis extending in an axial direction, and includes an annular rotor core, a rotor magnet fixed to an inner surface of the rotor core in a radial direction, and a protection portion that presses the rotor magnet against the rotor core from an inside in the radial direction, and fixes the rotor core and the rotor magnet.

An example embodiment of a motor of the present disclosure includes the rotor described above and a stator positioned on an inside of the rotor in the radial direction.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a longitudinal cross-sectional view of a motor according to a present example embodiment of the present disclosure.

FIG. 2 is a longitudinal cross-sectional view of a rotor according to the present example embodiment.

FIG. 3 is a perspective view illustrating a portion of the rotor according to the present example embodiment.

FIG. 4 is a perspective view of a core piece according to the present example embodiment.

FIG. 5 is a cross-sectional view of the core piece according to the present example embodiment.

FIG. 6 is a longitudinal sectional view of a core piece according to a modification example of the present example embodiment.

### DETAILED DESCRIPTION

In the following description, a positive side (+Z-side) of a Z-axis direction illustrated in the drawings is referred to as an “upper side”, and a negative side (−Z-side) of the Z-axis direction is referred to as a “lower side”. The terms “upper side” and “lower side” are directions merely used for the sake of convenience in description and do not limit poses of a rotor 30 and a motor 1 at the time of use. A center axis J illustrated in the drawings is a virtual line extending in parallel with the Z-axis direction. In the following description, a direction parallel to the center axis J (that is, the Z-axis direction) is simply referred to as an “axial direction”, a radial direction about the center axis J is simply referred to as a “radial direction”, and a circumferential direction about the center axis J is simply referred to as a “circumferential direction” unless otherwise specified. In the present example embodiment, the upper side corresponds to one axial direction side.

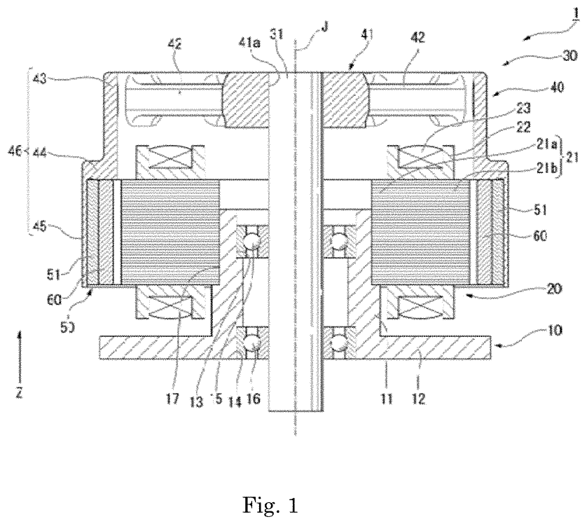

The motor 1 of the present example embodiment illustrated in FIG. 1 is an outer-rotor motor. As illustrated in FIG. 1, the motor 1 includes a base member 10, a stator 20, and the rotor 30.

The base member 10 includes a base tubular portion 11 and a flange portion 12 expanding to an outside in the radial direction from a lower end portion of the base tubular portion 11. The base tubular portion 11 has a first large inner diameter portion 13 and a second large inner diameter portion 14 having large inner diameters at an upper end and a lower end. The first large inner diameter portion 13 accommodates a first bearing 15. The second large inner diameter portion 14 accommodates a second bearing 16. An upper portion of the base tubular portion 11 is a small outer diameter portion 17 having an outer diameter smaller than that of a lower portion of the base tubular portion 11.

The stator 20 is positioned on an inside of the rotor 30 in the radial direction. The stator 20 is fixed to the base member 10. The stator 20 includes a stator core 21, a plurality of insulators 22, and a plurality of coils 23.

The stator core 21 includes a core back portion 21a in an annular shape with the center axis J as the center and a plurality of tooth portions 21b extending to an outside in the radial direction from an outer peripheral end of the core back portion 21a. The small outer diameter portion 17 of the base tubular portion 11 is fitted inside the core back portion 21a in the annular shape. The core back portion 21a is fixed to the small outer diameter portion 17 by, for example, press fitting. Although not illustrated, the plurality of tooth portions 21b are arranged at intervals in the circumferential direction.

The coil 23 is made of a coil wire wound in multiple layers. Each of the plurality of coils 23 is attached to the tooth portion 21b via each insulator 22.

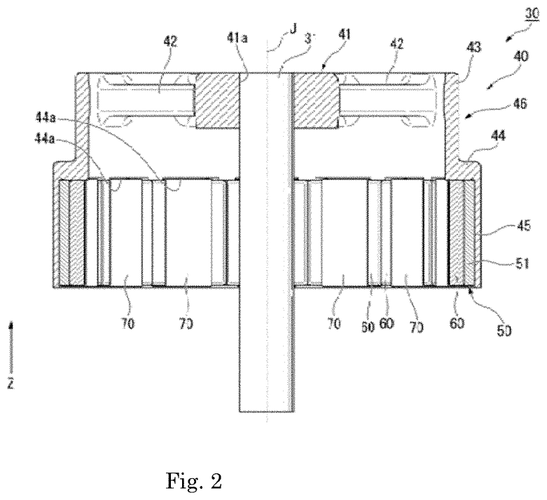

The rotor 30 is capable of rotating about the center axis J extending in the axial direction. As illustrated in FIG. 2, the rotor 30 includes a shaft 31, a rotor holder 40, a rotor core 50, rotor magnets 60, and protection portions 70. The shaft 31 has a columnar shape extending in the axial direction with the center axis J as the center. As illustrated in FIG. 1, the shaft 31 is rotatably supported by the first bearing 15 and the second bearing 16.

The rotor holder 40 is fixed to the shaft 31. The rotor holder 40 includes a shaft fixing portion 41 fixed to the shaft 31, a plurality of connecting portions 42 extending to an outside in the radial direction from the shaft fixing portion 41, and a tubular portion 46 connected to the shaft fixing portion 41 via the plurality of connecting portions 42. The shaft fixing portion 41 has a central through-hole 41a about the center axis J. An upper end portion of the shaft 31 is fitted and fixed to the central through-hole 41a.

In the present example embodiment, the tubular portion 46 has a cylindrical shape opened onto both sides in the axial direction with the center axis J as the center. The tubular portion 46 includes an upper tubular portion 43, a support portion 44, and a lower tubular portion 45. That is, the rotor holder 40 includes the upper tubular portion 43, the support portion 44, and the lower tubular portion 45. The upper tubular portion 43 is an upper portion of the tubular portion 46. Outer end portions of the plurality of connecting portions 42 in the radial direction are connected to an inner peripheral surface of an upper end portion of the upper tubular portion 43.

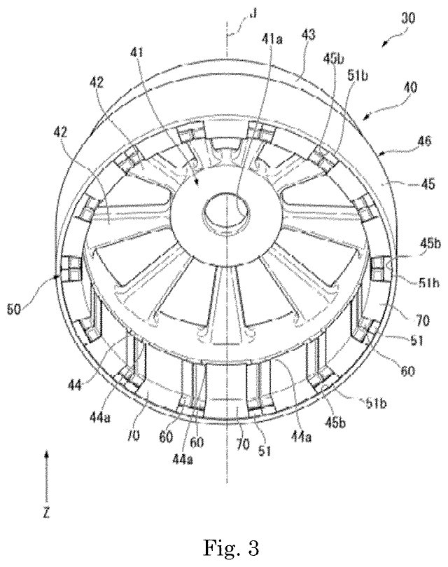

The support portion 44 protrudes to an outside in the radial direction from a lower end portion of the upper tubular portion 43. In the present example embodiment, the support portion 44 has an annular shape with the center axis J as the center. The support portion 44 supports the rotor core 50 from above. As illustrated in FIGS. 2 and 3, in the present example embodiment, the support portion 44 has second groove portions 44a recessed in the axial direction. The second groove portions 44a are recessed upward from a lower surface of the support portion 44. The second groove portions 44a extend in the circumferential direction. The second groove portions 44a are opened to an inside in the radial direction, for example. In the present example embodiment, a plurality of second groove portions 44a are provided at intervals in the circumferential direction. The plurality of second groove portions 44a are arranged at equal intervals over the entire circumference along the circumferential direction. In the present example embodiment, 14 second groove portions 44a are provided. In the present example embodiment, the number of second groove portions 44a is the same as the number of rotor magnets 60 and the number of protection portions 70.

As illustrated in FIG. 2, the lower tubular portion 45 extends downward from an outer edge portion of the support portion 44 in the radial direction. The lower tubular portion 45 is a lower portion of the tubular portion 46. The rotor core 50 is fixed to an inner peripheral surface of the lower tubular portion 45. The lower tubular portion 45 surrounds the rotor core 50 from an outside in the radial direction. A thickness of a wall portion in the radial direction, which constitutes the lower tubular portion 45 is smaller than a thickness of a wall portion in the radial direction, which constitutes the upper tubular portion 43. As illustrated in FIG. 3, rotation stopping portions 45b capable of suppressing a relative rotation between the rotor holder 40 and the rotor core 50 are provided on an inner surface of the lower tubular portion 45 in the radial direction. In the present example embodiment, the rotation stopping portions 45b are recesses recessed to an outside in the radial direction from the inner peripheral surface of the lower tubular portion 45. Although not illustrated, the rotation stopping portions 45b extend from an upper end to a lower end of the inner peripheral surface of the lower tubular portion 45. A plurality of rotation stopping portions 45b are provided at intervals in the circumferential direction. The plurality of rotation stopping portions 45b are arranged at equal intervals over the entire circumference along the circumferential direction. In the present example embodiment, seven rotation stopping portions 45b are provided.

The rotor core 50 has an annular shape surrounding the center axis J. The rotor core 50 is fitted into the lower tubular portion 45. An outer surface of the rotor core 50 in the radial direction is in contact with the inner peripheral surface of the lower tubular portion 45. An upper surface of the rotor core 50 is in contact with the lower surface of the support portion 44. In the present example embodiment, the rotor core 50 is formed by connecting a plurality of core pieces 51 in the circumferential direction. The rotor core 50 of the present example embodiment is formed by connecting seven core pieces 51 in an annular shape.

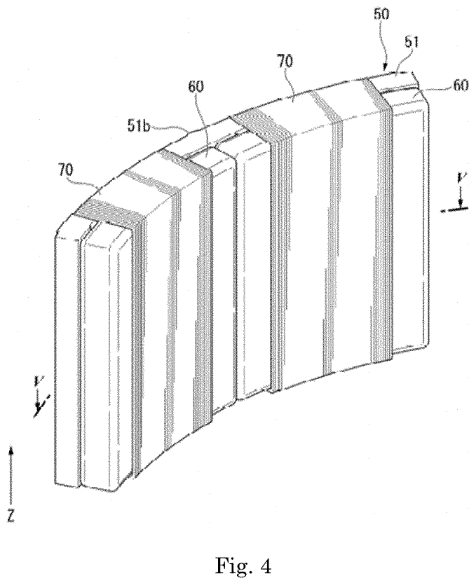

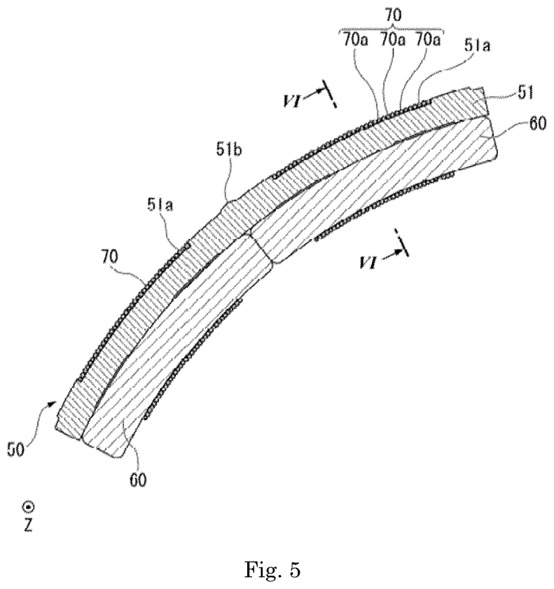

As illustrated in FIGS. 3 and 4, rotation stopping portions 51b capable of suppressing a relative rotation between the rotor core 50 and the rotor holder 40 are provided on the outer surface of the rotor core 50 in the radial direction. In the present example embodiment, the rotation stopping portions 51b are convex portions protruding to an outside in the radial direction from the outer surface of the rotor core 50 in the radial direction. The rotation stopping portions 51b extend from an upper end to a lower end of the outer surface of the rotor core 50 in the radial direction. As illustrated in FIG. 3, a plurality of rotation stopping portions 51b are provided at intervals in the circumferential direction. The plurality of rotation stopping portions 51b are arranged at equal intervals over the entire circumference along the circumferential direction. In the present example embodiment, one rotation stopping portion 51b is provided for each core piece 51. That is, seven rotation stopping portions 51b are provided. As illustrated in FIGS. 4 and 5, the rotation stopping portions 51b are provided at a central portion in the circumferential direction of an outer surface of the core piece 51 in the radial direction. As illustrated in FIG. 3, each rotation stopping portion 51b is fitted into each rotation stopping portion 45b provided in the rotor holder 40. The concave rotation stopping portion 45b is caught in the convex rotation stopping portion 51b provided on the outer surface of the rotor core 50 in the radial direction in a rotation direction, and thus, the relative rotation between the rotor core 50 and the rotor holder 40 is suppressed.

As illustrated in FIG. 5, in the present example embodiment, first groove portions 51a recessed to an inside in the radial direction are provided on the outer surface of the rotor core 50 in the radial direction. For example, the first groove portions 51a extend in the axial direction from the upper end to the lower end of the rotor core 50. A plurality of first groove portions 51a are provided at intervals in the circumferential direction. The plurality of first groove portions 51a are arranged at equal intervals over the entire circumference along the circumferential direction. In the present example embodiment, two first groove portions 51a are provided for each core piece 51. That is, in the present example embodiment, 14 first groove portions 51a are provided. The number of first groove portions 51a is the same as the number of rotor magnets 60 and the number of protection portions 70. In each core piece 51, two first groove portions 51a are arranged on the outer surface of the core piece 51 in the radial direction with the rotation stopping portion 51b interposed therebetween in the circumferential direction.

As illustrated in FIG. 4, the rotor magnets 60 are fixed to an inner surface of the rotor core 50 in the radial direction. The rotor magnets 60 extend in an arc shape when viewed in the axial direction. As illustrated in FIG. 1, an inner surface of the rotor magnet 60 in the radial direction is disposed to face an outside of the tooth portion 21b in the radial direction with a gap therebetween. The inner surface of the rotor magnet 60 in the radial direction is positioned on an outside in the radial direction from the inner peripheral surface of the upper tubular portion 43. An upper surface of the rotor magnet 60 is in contact with the lower surface of the support portion 44. As illustrated in FIG. 3, a plurality of rotor magnets 60 are provided along the circumferential direction. In the present example embodiment, two rotor magnets 60 are provided for each core piece 51. The number of rotor magnets 60 is, for example, 14. The core piece 51 and the rotor magnet 60 are bonded to each other by, for example, an adhesive. The plurality of rotor magnets 60 are provided adjacent to each other in the circumferential direction. The plurality of rotor magnets 60 are arranged adjacent to each other in the circumferential direction, and the rotor magnets are combined in a cylindrical shape with the center axis J as the center.

In the present example embodiment, magnetic poles of the rotor magnets 60 are arranged in a Halbach array. The rotor magnet 60 of the present example embodiment includes, for example, an N-pole portion in which a magnetic pole on an outside in the radial direction is an N-pole, an S-pole portion in which a magnetic pole on an outside in the radial direction is an S-pole, and a magnetic pole portion positioned between the N-pole portion and the S-pole portion and magnetized in a mode in which a magnetization direction is from the S-pole portion to the N-pole portion.

As illustrated in FIG. 4, the protection portions 70 are members that fix the rotor cores 50 and the rotor magnets 60. The protection portion 70 is an elongated member. In the present example embodiment, the protection portion 70 is a thread-shaped member. As illustrated in FIG. 5, a cross section of the thread-shaped protection portion 70 has, for example, a circular shape. A material of the protection portion 70 is not particularly limited, but it is preferable that the protection portion has durability to such an extent that the protection portion cannot be cut while the motor is driven. In the present example embodiment, the protection portion 70 is a non-magnetic member. The protection portion 70 is made of, for example, a resin. Examples of the resin forming the protection portion 70 include a polyamide resin and the like. The protection portion 70 has elasticity.

As illustrated in FIG. 4, the protection portion 70 passes through the outside of the rotor core 50 in the radial direction, the inside of the rotor magnet 60 in the radial direction, and both sides of the rotor core 50 and the rotor magnet 60 in the axial direction, and is wound around the rotor core 50 and the rotor magnet 60. That is, the protection portion 70 is wound around the rotor core 50 and the rotor magnet 60 in a poloidal direction with the center axis J as the center. For example, the protection portion 70 is wound around the rotor core 50 and the rotor magnet 60 multiple times in a state where tension is applied. As illustrated in FIG. 5, a plurality of wound portions 70a of the protection portion 70 are arranged in a line along the circumferential direction. The number of windings of the protection portion 70 is not particularly limited, and the plurality of wound portions 70a may be wound so as to be arranged in two or more rows along the circumferential direction. In the present example embodiment, the protection portion 70 is wound around a central portion of each rotor magnet 60 in the circumferential direction. The protection portion 70 is not wound around both end portions of each rotor magnet 60 in the circumferential direction.

In the present example embodiment, a part of the protection portion 70 is positioned in the first groove portion 51a of the core piece 51. More specifically, a portion of the protection portion 70 positioned on the outside of the rotor core 50 in the radial direction is disposed in the first groove portion 51a. In the present example embodiment, a thickness (outer diameter) of the thread-shaped protection portion 70 is equal to or less than a depth of the first groove portion 51a in the radial direction. As illustrated in FIGS. 2 and 3, in the present example embodiment, a part of the protection portion 70 is positioned in the second groove portion 44a. More specifically, a portion of the protection portion 70 positioned above the rotor core 50 and above the rotor magnet 60 is disposed in the second groove portion 44a.

The rotor core 50, the rotor magnet 60, and the protection portion 70 are bonded to each other. For example, the protection portion 70 is wound around the rotor core 50 and the rotor magnet 60, and is then fixed with an adhesive. Examples of the adhesive may include an epoxy-based adhesive, and the like.

According to the present example embodiment, the rotor 30 includes the protection portion 70 that presses the rotor magnet against the rotor core 50 from the inside in the radial direction and fixes the rotor core 50 and the rotor magnet 60. Thus, the protection portion 70 can prevent the rotor magnet 60 from being detached to an inside in the radial direction from the rotor core 50. Accordingly, for example, even when a relatively large force toward an inside in the radial direction is applied to the rotor magnet 60, such as a case where an electromagnetic force to the rotor magnet 60 toward an inside in the radial direction is larger than a centrifugal force applied to the rotor magnet 60 toward an outside in the radial direction due to the rotation of the rotor 30, the rotor magnet 60 can be prevented from being detached.

According to the present example embodiment, the rotor core 50 is formed by connecting the plurality of core pieces 51 in the circumferential direction, and at least one rotor magnet 60 is fixed to each of the core pieces 51 by the protection portion 70. In this configuration, since the rotor core 50 is a split core, the rotor magnet 60 can be individually attached to each core piece 51 by using the protection portion 70. Thus, the rotor magnet 60 can be easily fixed by the protection portion 70. Specifically, in the present example embodiment, the elongated protection portion 70 can be easily wound around the core piece 51 and the rotor magnet 60.

According to the present example embodiment, the rotor core 50, the rotor magnet 60, and the protection portion 70 are bonded to each other. Thus, the protection portion 70 is loosen, and thus, the rotor magnet can be prevented from being detached, and the state where the rotor magnet 60 is fixed to the rotor core 50 by the protection portion 70 can be more strongly maintained.

According to the present example embodiment, the protection portion 70 passes through the outside of the rotor core 50 in the radial direction, the inside of the rotor magnet 60 in the radial direction, and both the sides of the rotor core 50 and the rotor magnet 60 in the axial direction, and is wound around the rotor core 50 and the rotor magnet 60. In this configuration, it is easy to more firmly fix the rotor core 50 and the rotor magnet 60 by the protection portion 70. That is, in the rotor 30, it is possible to further prevent the rotor magnet 60 from being detached from the rotor core 50.

According to the present example embodiment, the protection portion 70 has the thread shape. The protection portion 70 has the thread shape, and thus, it is possible to easily attach the protection portion 70 in a winding mode in the present example embodiment. The protection portion 70 has the thread shape, and thus, a thickness of the protection portion 70 in a state where the rotor magnet 60 is fixed to the rotor core 50 can be relatively thin. Thus, even though a part of the protection portion 70 is positioned on the inside of the rotor magnet 60 in the radial direction as in the present example embodiment, the protection portion 70 can be prevented from coming into contact with the stator 20.

According to the present example embodiment, the first groove portions 51a recessed in the radial direction are provided on the outer surface of the rotor core 50 in the radial direction, and a part of the protection portion 70 is positioned in the first groove portion 51a. In this configuration, it is possible to prevent the protection portion 70 from protruding to the outside in the radial direction from the rotor core 50. Accordingly, the rotor core 50 in a state where the rotor magnet 60 is fixed by the protection portion 70 can be suitably and easily fixed to an inner peripheral surface of the tubular portion 46. It is possible to prevent the entire rotor 30 from becoming large in the radial direction. The first groove portion 51a is provided on the rotor core 50 side, and thus, it is possible to prevent an increase in a dimension of the tubular portion 46 in the radial direction, and it is possible to prevent an increase in an outer diameter of the tubular portion 46 as compared with a case where the first groove portion is provided on an inner surface of the tubular portion 46 in the radial direction.

According to the present example embodiment, the rotor holder 40 having the support portion 44 that supports the rotor core 50 from above (one side in the axial direction) is provided, and the support portion 44 has the second groove portion 44a recessed in the axial direction. A part of the protection portion is positioned in the second groove portion 44a. In this configuration, even though a part of the protection portion 70 is positioned above the rotor core 50, a part of the protection portion 70 can be disposed in the second groove portion 44a, and a portion of an upper end portion of the rotor core 50 that is not fixed by the protection portion 70 can be suitably supported by the support portion 44.

According to the present example embodiment, the magnetic poles of the rotor magnets 60 are arranged in a Halbach array. Thus, the magnetic force generated between the stator 20 and the rotor 30 can be increased, and an output of the motor 1 can be improved.

Since the magnetization directions of the plurality of rotor magnets 60 arranged in the Halbach array are different from each other between the adjacent rotor magnets 60, the rotor magnets 60 are easily repelled by the magnetic force of each other, and are hardly fixed to the rotor core 50. Here, in the present example embodiment, the rotor core 50 and the rotor magnet 60 are fixed by the protection portion 70. In the configuration in which the rotor magnets 60 are arranged in the Halbach array, it is possible to more effectively obtain the effect that the rotor magnet 60 can be prevented from being detached in the rotor 30 described above.

In the present example embodiment, the protection portion 70 is a non-magnetic member. Thus, it is possible to prevent generation of eddy current at the protection portion 70 by a magnetic flux as compared with a case where the protection portion 70 is a magnetic member. Accordingly, it is possible to reduce a loss caused by the eddy current, and it is possible to prevent an increase in temperature of the rotor 30 by the eddy current.

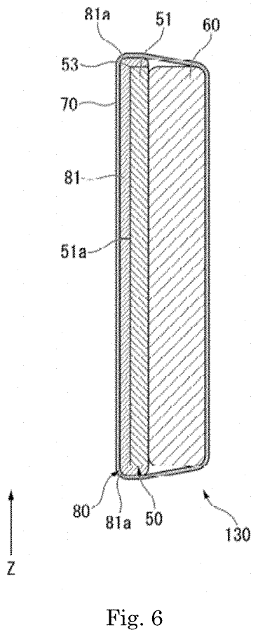

As illustrated in FIG. 6, in a modification example of the present example embodiment, a rotor 130 includes an intermediate portion 80. The intermediate portion 80 is attached to the rotor core 50. In the present modification example, the intermediate portion 80 covers the outside of the rotor core 50 in the radial direction and both the sides of the rotor core 50 in the axial direction. In the present modification example, the intermediate portion 80 is a non-magnetic member. The intermediate portion 80 is made of, for example, a resin. In the present example embodiment, a portion of the intermediate portion 80 positioned on the outside of the rotor core 50 in the radial direction is accommodated in the first groove portion 51a. The intermediate portion 80 protrudes to both the sides in the axial direction from the rotor core 50 in the axial direction.

The intermediate portion 80 has an intervening portion 81 positioned between the rotor core 50 and the protection portion 70. In the rotor 130 of the present modification example, an inner portion of the protection portion 70 in the radial direction, the rotor magnet 60, the rotor core 50, the intervening portion 81 of the intermediate portion 80, an outer portion of the protection portion 70 in the radial direction, and the lower tubular portion are arranged in this order from the inside in the radial direction.

The intervening portion 81 has curved surfaces 81a with which the protection portion 70 comes into contact. In the present modification example, the curved surface 81a is provided at each of an outer end portion in the radial direction, of end portions on both sides of the intervening portion 81 in the axial direction. Portions of the intervening portion 81 where the curved surfaces 81a are provided covers edge portions 53 positioned at both ends of the first groove portion 51a in the axial direction. That is, the protection portion 70 is wound around the edge portion 53 via the curved surface 81a.

According to the present modification example, the intermediate portion 80 attached to the rotor core 50 is provided. The intermediate portion 80 has the intervening portion 81 positioned between the rotor core 50 and the protection portion 70, and the intervening portion 81 has the curved surfaces 81a with which the protection portion 70 comes into contact. In this configuration, the protection portion 70 can be wound around the rotor core 50 via the curved surfaces 81a of the intervening portion 81. Thus, even when the edge portions 53 of the rotor core 50 are sharp or the like, it is possible to prevent the protection portion 70 from being damaged when the protection portion 70 is wound around the rotor core 50 by applying tension.

In the present modification example, the intermediate portion 80 is the non-magnetic member. Thus, it is possible to prevent generation of eddy current at the intermediate portion 80 by a magnetic flux as compared with a case where the intermediate portion 80 is a magnetic member. Accordingly, it is possible to reduce a loss caused by the eddy current, and it is possible to prevent an increase in temperature of the rotor 30 by the eddy current.

In the present example embodiment and the modification example of the present example embodiment described above, the first groove portion 51a is provided on the outer surface of the core piece 51 in the radial direction, but the present disclosure is not limited thereto. The first groove portion 51a may be provided on the inner surface of the tubular portion 46 in the radial direction. More specifically, the first groove portion 51a may be provided on the inner surface of the lower tubular portion 45 in the radial direction. In this configuration, even though a part of the protection portion 70 is positioned on the outside of the rotor core 50 in the radial direction, a part of the protection portion 70 can be disposed in the first groove portion 51a provided in the lower tubular portion 45, and a portion of the outer surface of the rotor core 50 in the radial direction that is not fixed by the protection portion 70 can be suitably supported by the inner surface of the lower tubular portion 45 in the radial direction.

The first groove portions 51a may be provided on both the outer surface of the core piece 51 in the radial direction and the inner surface of the lower tubular portion 45 in the radial direction. In this case, a part of the protection portion 70 is positioned in the first groove portion 51a on the core piece 51 side and in the first groove portion on the lower tubular portion 45 side, and the same effect as that of the previous stage can be obtained. A method for providing the first groove portion 51a on the outer surface of the rotor core 50 in the radial direction and the inner surface of the lower tubular portion 45 in the radial direction can be appropriately selected according to required dimensions and strength of the rotor 30 and the motor 1.

The rotor magnet 60 is not limited to the present example embodiment, and for example, one rotor magnet 60 may be provided for one core piece 51.

The protection portion 70 is not limited to the thread-shaped member illustrated in the present example embodiment. The protection portion 70 is preferably accommodated in the first groove portion 51a, and may be, for example, a belt-shaped member or a sheet-shaped member.

In the present example embodiment, the protection portion 70 is wound around and fixed to the rotor core 50 and the rotor magnet 60 multiple times, but the number of times and a fixing method are not limited. For example, the protection portion 70 may be a member to which a wide ring-shaped member having elasticity is attached. In the present example embodiment, the protection portion 70 is wound along a plane perpendicular to the circumferential direction, but may be wound obliquely, for example, as long as the protection portion passes through the outside of the rotor core 50 in the radial direction, the inside of the rotor magnet 60 in the radial direction, and both the sides of the rotor core 50 and the rotor magnet 60 in the axial direction.

Although the example embodiment of the present disclosure has been described above, the configuration in the example embodiment is merely an example, and therefore addition, omission, substation and other alterations may be appropriately made within the scope of the present disclosure. Also note that the present disclosure is not limited by the example embodiment.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A rotor rotatable about a center axis extending in an axial direction, the rotor comprising:
an annular rotor core;
a rotor magnet fixed to an inner surface of the rotor core in a radial direction; and
a protection portion that presses the rotor magnet against the rotor core from an inside in the radial direction, and fixes the rotor core and the rotor magnet.

2. The rotor according to claim 1, wherein
the rotor core includes a plurality of core pieces connected in a circumferential direction;
a plurality of the rotor magnets are provided; and
at least one of the plurality of rotor magnets is fixed to each of the plurality of core pieces by the protection portion.

3. The rotor according to claim 1, wherein the rotor core, the rotor magnet, and the protection portion are bonded to each other.

4. The rotor according to claim 1, wherein the protection portion extends through an outside of the rotor core in the radial direction, an inside of the rotor magnet in the radial direction, and two sides of the rotor core and the rotor magnet in the axial direction, and is wound around the rotor core and the rotor magnet.

5. The rotor according to claim 4, further comprising:
an intermediate portion attached to the rotor core; wherein
the intermediate portion includes an intervening portion positioned between the rotor core and the protection portion; and
the intervening portion includes a curved surface with which the protection portion comes in contact.

6. The rotor according to claim 4, wherein the protection portion has a thread shape.

7. The rotor according to claim 1, further comprising:
a rotor holder including a tubular portion that surrounds the rotor core from an outside in the radial direction; wherein
a first groove portion recessed in the radial direction is provided on at least one of an outer surface of the rotor core in the radial direction and an inner surface of the tubular portion in the radial direction; and
a portion of the protection portion is positioned in the first groove portion.

8. The rotor according to claim 1, further comprising:
a rotor holder including a support portion that supports the rotor core from one side in the axial direction; wherein
the support portion includes a second groove portion recessed in the axial direction; and
a portion of the protection portion is positioned in the second groove portion.

9. The rotor according to claim 1, wherein magnetic poles of the rotor magnet are arranged in a Halbach array.

10. A motor comprising:
the rotor according to claim 1; and
a stator positioned on an inside of the rotor in the radial direction.
